(19) United States
(12) Patent Application Publication
(10) Pub. No.: US 2015/0369918 A1
(43) Pub. Date: Dec. 24, 2015

(54) LASER ALIGNMENT AND TRACKING SYSTEM

(71) Applicants: Brian S. Tacke, Fredericksburg, VA (US); Michael T. Duckett, Fredericksburg, VA (US); Robert D. Moran, King George, VA (US)

(72) Inventors: Brian S. Tacke, Fredericksburg, VA (US); Michael T. Duckett, Fredericksburg, VA (US); Robert D. Moran, King George, VA (US)

(73) Assignee: SYNTRONICS, LLC, Fredericksburg, VA (US)

(21) Appl. No.: 14/705,672

(22) Filed: May 6, 2015

Related U.S. Application Data
(60) Provisional application No. 62/014,947, filed on Jun. 20, 2014.

(51) Int. Cl. G01S 17/06; G01S 7/486; G01B 11/27

(52) U.S. Cl. CPC G01S 17/06; G01B 11/272; G01S 7/4865

(57) ABSTRACT

A laser alignment system for determining received pulse shape characteristics is provided. An exemplary laser alignment system may include a multi-channel optical detector including a plurality of light sensitive regions, each light sensitive region being associated with a respective one of a plurality of channels of the multi-channel optical detector and being configured to detect energy of an incident laser pulse. The system may include a signal processing unit configured to determine a plurality of data points associated with a detected laser pulse and determine whether the plurality of data points correspond to an expected laser pulse response of a designator laser. The signal processing unit may then perform other post-processing operations and in some embodiments may output an alignment command based at least in part on the plurality of data points associated with the laser pulse when the detected laser pulse corresponds to the expected laser pulse response.

### CROSS-REFERENCE TO RELATED APPLICATIONS

This application claims priority to U.S. Provisional Application No. 62/014,947 filed Jun. 20, 2014, the entirety of which is incorporated herein by reference.

### TECHNICAL FIELD

The present disclosure relates to systems and methods for alignment and/or tracking of one or more objects based on a detected signal. Some embodiments may include a laser alignment device for aligning a movable object with a laser-designated point or location on another object.

### BACKGROUND

There are numerous and diverse applications that rely on the detection and processing of received laser energy by a detector. These applications may include a designator laser such as a laser source/emitter for emitting laser radiation. These applications also include a detector for detecting and processing the received laser energy, which may be further processed to provide desired functionality for a particular application. The detector may be provided separately from the laser designator or co-located with the laser designator depending on the specific application.

For example, telescope mirrors may be aligned using a laser and a detector arrangement. Over relatively large distances, the mirrors may be aligned to a laser reference signal. In guided projectile applications, a pulsing laser source may be shone on a target, and electronics associated with a projectile launched toward the target may detect reflected energy from the laser pulse and develop steering commands to align the projectile with the point of reflection at the target. Tunnel boring machines use lasers to maintain accurate control of the drilling paths; precise enough to allow two machines to bore towards each other over miles of distance and ultimately meet with nearly perfect alignment of the two tunnel ends. In addition, pulsed lasers may be used for the measurement of range for both military and civilian applications. For example, laser ranging may be used to measure distance for artillery fire control and for the activation of a proximity fuse. Laser ranging may also be used in surveying, hunting, and other sporting applications such as golf. Though the applications vary greatly, the processing required to achieve the desired end results may be similar.

Many laser detection applications may rely on an intermittent or pulsed laser source, such as a semi-active laser source (“SAL”). A SAL detector/seeker implementation may use an optical detector such as a quad channel detector for sensing the emitted and reflected laser energy. Laser energy sensed by the detector channels may be analog summed, and the sum may be compared against a predetermined threshold value. When the threshold value is exceeded, an analog peak detector may hold a detected value and output a response when the detected laser signal drops below the held value, upon which it is assumed that the held value corresponds to the peak of the pulse. This may trigger the signal values of the detector channels to be latched by a plurality of sample and hold circuits or stored in the peak detector, and an analog-to-digital converter (ADC) cycle may then be triggered to convert each channel's held data values into digital data values. These digital data values may comprise the energy values of a detected laser pulse for what may be termed a pulse event. The pulse event values are then queued for subsequent processing. In traditional systems for guiding a moving object, subsequent processing may generate guidance commands based on the energy values of the detected laser pulse, typically defined as Line of Sight (LOS) commands or errors expressed in pitch and yaw components.

In the traditional configuration, the detector hardware is then reset and ready to process the next pulse event based on received laser energy above a predetermined threshold. The threshold logic, however, may prevent further detection until the earlier signal falls below the threshold, eliminating the ability to identify closely spaced pulse events. When searching for an expected laser pulse signal, the amount of sensor data that can actually be processed is limited by the speed of the sample and hold circuits, ADC, and queued sample event processing throughput of the detector hardware.

The delay associated with the traditional configuration provides only the capability to detect a peak value of a pulse event and/or a pulse width as may be determined according to detected predetermined threshold crossings, but no other details regarding a received pulse can be determined. Thus, in the traditional configuration, when generating the guidance commands from the quad channel samples of the detector, generally only one sample of a pulse event is used in the calculation, and that sample corresponds to an approximate peak value of the pulse event. As a result, very little noise reduction through signal processing is available or possible in these traditional configurations. Additionally, pulse shape variations resulting from multi-path reflections, dust, or other clutter in the immediate vicinity of a desired target cannot be discriminated from the expected return pulse reflecting from the target. And, in the traditional configuration, pulse signals below the predetermined threshold are discarded, potentially resulting in the inability to detect the desired pulse event under some circumstances where the laser energy returned from the desired target is less than that of other background noise. Because, in these systems, detected peak signal values are deemed to correspond to a pulse event, the probability of detection and tracking of a laser source signal at low signal-to-noise levels requires significantly more processing capability to eliminate false pulse events.

Accordingly, systems are needed that enable detection of the shape and other characteristics of an expected laser pulse response, as in the proposed embodiments. Such systems may increase the detection and tracking range probability in laser detection and alignment systems, among other advantages.

### SUMMARY

The present disclosure provides systems and methods for detecting an expected laser pulse signal in a detector system and for aligning a moving object toward a target based on the detected laser pulse signal. In one aspect, the disclosure is directed to a laser alignment system comprising a multi-channel optical detector including a plurality of light sensitive regions, each light sensitive region being associated with a respective one of a plurality of channels of the multi-channel optical detector and being configured to detect energy of an incident laser pulse. The system may also comprise a signal processing unit configured to determine a plurality of data samples associated with a detected laser pulse, determine whether the plurality of data samples correspond to an expected laser pulse response, and output an alignment command based at least in part on the plurality of data samples associated with the detected laser pulse when the detected laser pulse corresponds to the expected laser pulse response.

### BRIEF DESCRIPTION OF THE DRAWINGS

FIG. 1 is a diagrammatic illustration of an exemplary signal detection system for detecting and processing received signals;

FIG. 2 is a diagrammatic illustration of an exemplary digital detector system that may be implemented in the system of FIG. 1 for detecting and processing received signals;

FIG. 3 is an illustration of an exemplary data processing pipeline that may be implemented using the system of FIG. 2 for detecting and processing received signals;

FIG. 4 is an illustration of threshold detection of a received signal that may be implemented using the system of FIG. 1 for detecting and processing received signals;

FIG. 5 is an illustration of a tracking window that may be implemented using the system of FIG. 1 for detecting and processing received signals;

FIG. 6 is a diagrammatic illustration of an exemplary laser alignment system for aligning a moving object with a target.

### DETAILED DESCRIPTION

The present disclosure relates to a high-speed signal detection and processing system/device that in some embodiments may be implemented as a laser alignment device for aligning a movable object with a target reflecting a laser signal. The present disclosure, however, is not limited to laser alignment systems or the detection of a laser signal. For example, while certain disclosed embodiments may include a quad detector for detecting and tracking a laser source, other embodiments may include detectors suitable for detecting any other signal sources in which high-speed data analysis and collection using the disclosed signal detection and processing system may be desired. Such embodiments may include detectors and systems for analyzing signals relating to ultrasound, sonar, radar, and seismometer systems, among others. The disclosed embodiments may be implemented to include a variety of hardware configurations. In some cases, such configurations may offer compact, low-power, and reduced cost implementations providing enhanced detection and processing capability over traditional configurations.

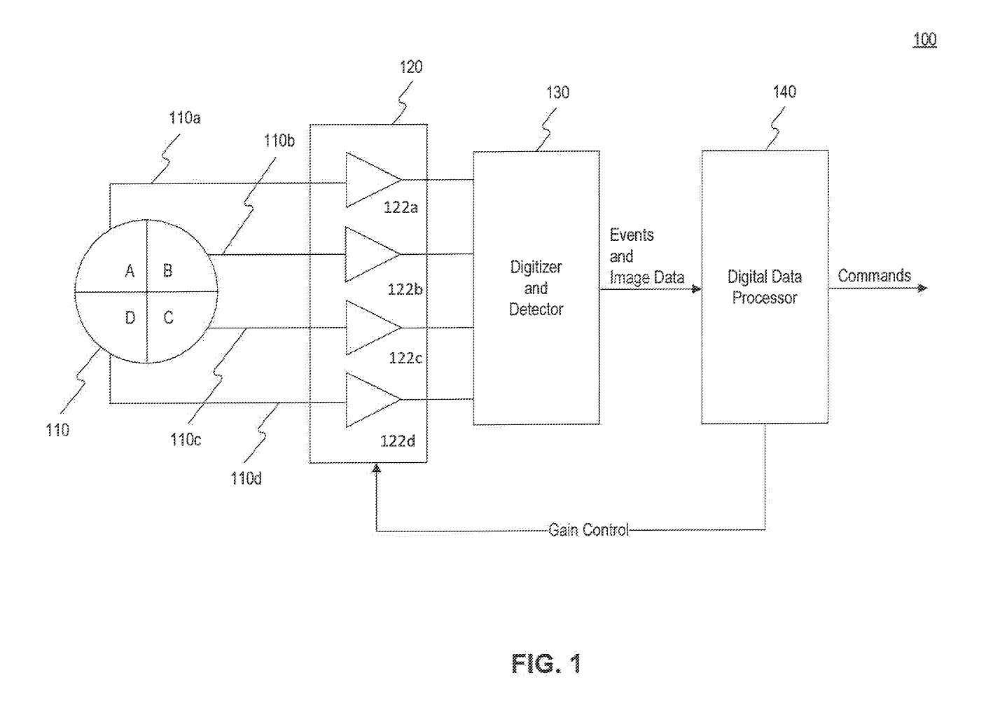

An exemplary detection and processing system 100, as shown in FIG. 1, may include an analog signal detector 110, which in some embodiments may include a quad channel optical detector, as shown. System 100 may also include pre-amplifier circuitry 120, digitizer and detector circuitry 130, and a digital data processor 140. In the exemplary embodiments, signal detector 110 may detect the intensity of a received signal and output one or more current/voltage signals proportional to the intensity of the received signal. Pre-amplifier circuitry 120 may be controlled via a gain control signal, for example, to provide a proportionally adjusted output current/voltage signal on each channel accounting for a dynamic range in intensity of the signal detected by signal detector 110. The adjusted analog output current signal may then be sampled and digitized by digitizer and detector circuitry 130 which may also process the digitized signal samples and perform signal detection and tracking operations according to the disclosed embodiments. Digitizer and detector circuitry 130 may output event detection data and raw digital data of the received signals to digital data processor 140, which may further process the digitized signals and output various commands or other data based on a particular application.

Signal detector 110 may include any known photo-sensitive optical detector for detecting an intensity of a light signal received from a source, such as for example a laser source/emitter. While an exemplary embodiment implements a photo-sensitive optical detector, signal detector 110 may include any other detector suitable for detecting radar, sonar, ultrasound, and other signals according to a desired implementation. In some embodiments, signal detector 110 may include a multi-channel optical detector comprising a plurality of quadrants, each associated with a distinct processing channel, as shown in FIG. 1. For example, signal detector 110 may include a quad channel optical detector divided into four quadrants designated ‘A’, ‘B’, ‘C’, and ‘D’ corresponding to channels 110a, 100b, 110c, and 110d, respectively.

Signal detector 110 may detect and process a received light signal from a laser source/emitter (not shown). Based on the received light signal incident on one or more of the quadrants of signal detector 110, the detector may output an analog current signal on each channel 110a-110d associated with each quadrant. The output current signal on each channel may be proportional to the intensity of the light or other signal detected by that quadrant. The proportional voltage associated with the output current signal for each channel may then be processed by the detection and processing system 100 according to a desired application. In some embodiments, the proportional current/voltage signals across the one or more channels may be used to align the detector 110 with a target reflecting the received signal.

Under some operating conditions, the intensity of the detected light (or other signal) may vary depending on the distance between the detector 110 and the light/signal source or a target reflecting the light source. In some embodiments, pre-amplifier circuitry 120 including one or more gain control amplifiers, 122a-122d, may be provided for each channel for adjusting the current signal output on each channel 110a-110d from the signal detector 110. Pre-amplifier circuitry 120 may be operable to provide an output current signal within a desired operating range based on the dynamic range of the received signal intensity.

The dynamic range of a detected light signal may vary in intensity by as much as six orders of magnitude (or more), from the weakest intensity to the brightest intensity. And because the disclosed embodiments may include the capability to discern signal pulses with low signal-to-noise ratio, the gain of pre-amplifier circuitry 120 in some embodiments may be dynamically adjustable to account for such a dynamic range, while maintaining a close match in the gain between each of the channels. Any known one or more gain control amplifiers 122a-122d or similar pre-amplifier circuitry 120 operable over such a range may be implemented in the exemplary system 100. For example, the disclosed embodiments may use one or more suitable variable-gain integrated circuits and modules such as those made by Analog Devices, Texas Instruments, MACOM, Analog Modules, Inc., and others. Additionally, one or more variable or switched gain amplifiers configured from fixed gain operational amplifiers, junction transistors, field effect transistors, diodes, digitally switched attenuators, and other variable gain methods known to those skilled in the art may be used in the disclosed embodiments.

As shown in FIG. 1, pre-amplifier circuitry 120 may include an interface to receive a gain control signal from digital data processor 140. In some embodiments, the gain control signal may be provided as part of an automatic gain control feedback loop directing pre-amplifier circuitry 120 to switch the gain of pre-amplifier circuitry 120 or reduce the gain proportionally according to the received gain control signal. The gain control signal may be controlled by digital data processor 140 according to the intensity of the received signals detected by signal detector 110 and received from the digitizer and detector circuitry 130. The interface of pre-amplifier circuitry 120 may receive one or more discrete gain control signals from the digital data processor 140. The one or more gain control signals may include an analog voltage signal or a digital command as in known in the art.

In an exemplary embodiment, pre-amplifier circuitry 120 may output a gain-adjusted signal for each of the incoming channels 110a-110d from signal detector 110. The output gain-adjusted signals may correspond to a proportional current value of the detected signal received by each quadrant of the quad channel optical detector 110 shown in FIG. 1. The proportional current value from each of the channels may then be passed to the digitizer and detector circuitry 130, which may convert the plurality of analog current signals of each channel 110a-110d to digital signal samples and perform additional signal detection processes using the digital signals.

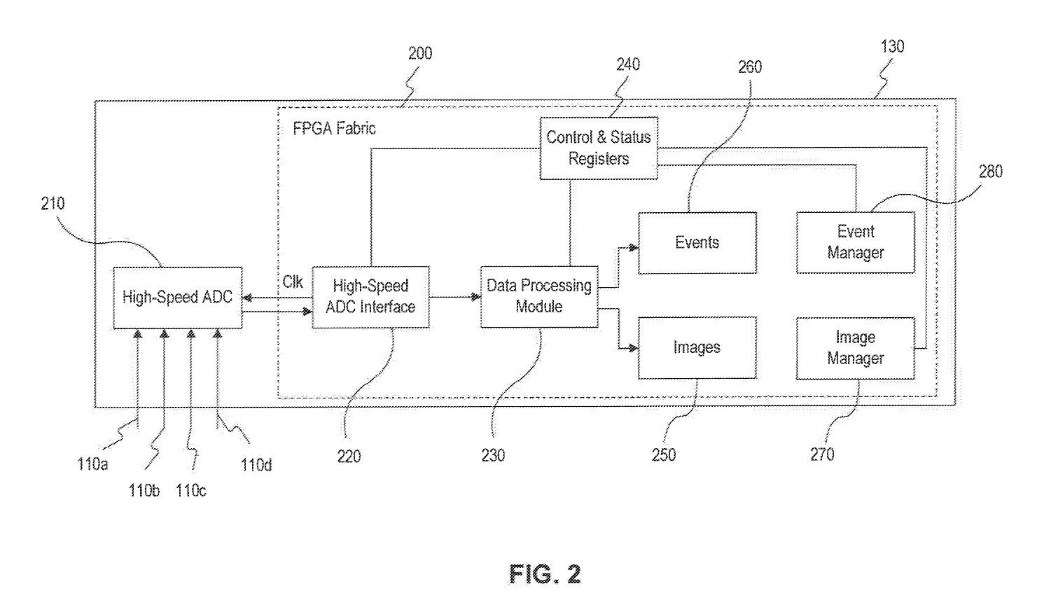

In an exemplary embodiment, as shown in FIG. 2, digitizer and detector circuitry 130 may include an analog-to-digital converter (ADC) module 210, which may include one or more ADCs for sampling and outputting a digital signal sample corresponding to the input analog current signal for each of the received channels. In some embodiments, an ADC may be provided for each channel of signal detector 110. For example, as shown in FIG. 2, the four processing channels, 110a-110d, output from signal detector 110 may be sampled by corresponding ADCs provided as part of ADC module 210, which may output corresponding digital signal samples for each channel. In some embodiments, ADC module 210 may output a digital data sample of 12 bits or higher. The output digital signal samples may then be provided to a digital detection module 200 for performing signal detection and tracking processes according to the exemplary embodiments.

Digital detection module 200 may include a plurality of logic components and other circuitry, memory units, and processing components for performing the exemplary signal detection and tracking process disclosed below. In some embodiments, digital detection module 200 may include a plurality of logic components and circuitry embodied in a field-programmable gate array (FPGA). The FPGA of digital detection module 200 may be interconnected to or closely integrated with a number of other processing components, such as one or more programmable microprocessors, and one or more storage components, including RAM and non-volatile storage memory modules. Digital detection module 200 may be programmed by one or more software instructions to perform the exemplary signal detection and tracking processes of the disclosed embodiments based on the digital signal samples received for each processing channel 110a-110d.

In the embodiment shown in FIG. 2, digital detection module 200 may include an ADC interface 220 comprising one or more input/output (I/O) pins for receiving the digital data samples from the ADC module 210 and for providing a clock signal (Clk) to the ADC module 210. Interface 220 may then direct the digital data samples to a data processing module 230, which may comprise a plurality of logic blocks of the FPGA for processing the received digitized data signals according to a desired operation. In some embodiments, data processing module 230 may process the digitized data signals in a pipelined manner, as discussed in greater detail below.

Digital detection module 200 may also include a plurality of control and status registers 240 for providing and receiving one or more control signals or other data to/from ADC interface 220, data processing module 230, image manager module 270 and event manager module 280 according to a desired operation. The control and status registers may be configurable by one or more programmable microprocessors or other signal processing components included in event manager 280 and image manager 270 or digital data processor 140 (in FIG. 1) to perform the desired functionality. Digital detection module 200 may also include an image storage module 250 and an event storage module 260, which may include one or more buffers or other data storage components for storing event detection data and raw image data. Image storage module 250 may receive and store raw image data corresponding to the digital data samples output from the ADC module 210 as may be selectively received from the data processing module 230 according to a control signal. Event storage module 260 may store event data detected by data processing module 230, which may also be selectively received according to a desired operation.

Digitizer and detector module 130 may output both event detection data based on the exemplary signal detection processes and raw image data received from each of the processing channels 110a-110d to a digital data processor 140 for further signal processing. Digital data processor may include any number of programmable processing components and circuitry for performing advanced signal processing operations for signal detection and tracking, for example, as well as other application specific processing commands. For example, in some embodiments, digital data processor 140 may process the received event and raw image data to generate guidance commands to align the signal detector 110 with a target reflecting the received light signal. Digital data processor 140 may include one or more digital signal processors, CPUs, or other processors capable of executing application specific software instructions to perform the disclosed functions.

In some embodiments, digital data processor 140 may be integrated with aspects of digitizer and detector module 130, such as image manager 270 and event manager 280. For example, in some embodiments, aspects of digital data processor 140 may be closely integrated with an FPGA comprising digital detection module 200. Digital data processor 140 may provide search, detection, and tracking control signals to digitizer and detector module 130 to control the data processes performed within that module, as detailed below. In some embodiments, the event detection control signals may be provided by image manager 270 and event manager 280, which as discussed above, may be closely integrated with digital detection module 200.

Detection and processing system 100 may improve upon traditional signal detection methods by digitizing the analog signals output from pre-amplifier circuitry 120 at a high sampling rate (approximately 125 Mhz and greater) and performing high-speed signal detection processes on the digitized signal samples to identify an intended signal. System 100 may use high-speed ADCs of ADC module 210 to generate digital signal samples at a high enough sampling rate to identify characteristics of the shape of the received signals. In some embodiments, system 100 may, even under low signal-to-noise operating conditions, identify an intended signal based on a comparison between the shape of an expected pulse response and the pulse shape characteristics of a received light signal. System 100 may process the digital signal samples in the data processing module 230, for example, in an iterative, pipelined manner at the approximate sampling rate of the ADC module 210 to detect potential pulse events among the digital signal samples. Thus, system 100 may process the received and digitized signals at a high data-throughput rate to enable improved signal detection performance and enhanced capabilities over traditional configurations.

In an exemplary embodiment, the analog signals provided on channels 110a-110d may be transmitted to ADC module 210 of digitizer and detection circuitry 130. In some embodiments, ADC module 210 may be associated with a clock or controlled by a clock signal (Clk) received from ADC interface 220. ADC module 210 may sample the received analog signals at a rate predetermined by a frequency of the clock signal received from ADC interface 220. In some embodiments, the clock signal may be clocked at a frequency of approximately 125 Mhz or greater. Thus, in some embodiments, ADC module 210 may output 125 million digital data samples of the received analog signal per second for each channel. In some embodiments comprising four processing channels as shown, ADC module 210 may output 500 million total digital data samples across the four channels. In such an implementation, a digital data sample on each channel may be generated approximately every 8 ns, thus enabling system 100 to capture a plurality of data samples for each received pulse signal. The number of samples detected for a received laser pulse signal may depend on the width of the generated laser pulse, which may be adjustable according to operating conditions (e.g. due to attenuation of the pulse width based on a bandwidth of pre-amplifier circuitry 120) or other desired functionality. But, according to the disclosed embodiments, sampling of the received signal at such a rate may enable system 100 to detect a pulse shape characteristic of the received laser pulse from the plurality of digital data samples of the received pulse. Sampling a received signal at a higher rate, such as 250 Mhz, for example, as enabled by the disclosed embodiments, may result in detection of a greater number of pulse samples to further enhance detection of a pulse shape characteristic of the received laser pulse. In the exemplary embodiments, system 100 may process the detected pulse shape characteristics of the received laser pulse to determine whether the received laser pulse corresponds to an expected laser pulse response and perform other processing functionality.

In some embodiments, ADC module 210 may sample the received analog signals on a rising edge, for example, of the clock signal from the ADC interface 220. In this embodiment, ADC module 210 may output a digital sample for each clock cycle at a rate based on the frequency of the clock signal. In another embodiment, ADC module 210 may include an additional ADC for each processing channel 110a-110d, comprising a second set of ADCs. The second set of ADCs may sample the received analog signals on the falling edge, for example, of the clock signal. In this embodiment, ADC module 210 may output a digital data sample for each half cycle of the clock signal, effectively doubling the number of digital samples for further processing thereby increasing performance capabilities of system 100.

The digital signal samples output from ADC module 210 may be transmitted to ADC interface 220, which may interface with digital detection module 200 embodied as an FPGA. The ADC interface 220 may transmit the received digital data samples to data processing module 230. ADC interface 220 may transmit the received digital data samples to the data processing module based on the clock signal controlling the ADC module 210. Thus, the output digital data samples may be transmitted to the data processing module 230 at the same rate as the digital sampling in the ADC module 210. In some embodiments implementing a second set of ADCs operating on a half-cycle of the clock signal, ADC interface 220 may receive digital data samples from the ADC module 210 in an interleaving manner on each half clock cycle and transmit the received digital data samples to data processing module 230 on each half cycle of the clock signal. The pipeline configuration of data processing module 230 may also process the interleaved digital data samples on each half clock cycle as determined by the falling or rising edge of the clock signal.

In some embodiments, each of the channels 110a-110d may be distinct processing channels input to and operated on by data processing module 230. Thus, although shown as a single input to data processing module 230, the digital data signals from each of the channels may be transmitted substantially simultaneously to data processing module 230. In an exemplary embodiment, data processing module 230 may include a plurality of logic blocks for processing the received digital data samples of each channel in a distinct pipeline operation. Thus, data processing module 230, as embodied in FPGA circuitry, may perform a number of pipelined operations on each of the distinct channels substantially simultaneously. In some embodiments, data processing module 230 may perform discrete logic operations on the distinct channels as controlled by the clock signal controlling the ADC module 210. As such, data processing module 230 may output processed raw image data for each of the channels to digital data processor 140 at substantially the same rate as the digital sampling rate of the ADC module 210. Thus, in some embodiments, operating under a 125 Mhz clock signal, data processing module 230 may output 500 million raw image data samples per second plus an additional 125 million image data samples corresponding to a summation of the 4 processing channels, as discussed below. In the exemplary embodiments, these output image data samples may be selectively received by digital data processor 140 or one or more digital signal processors to perform additional processing on selective samples of image data. In some embodiments, the selective samples of image data may correspond to images associated with event detection data generated by data processing module 230.

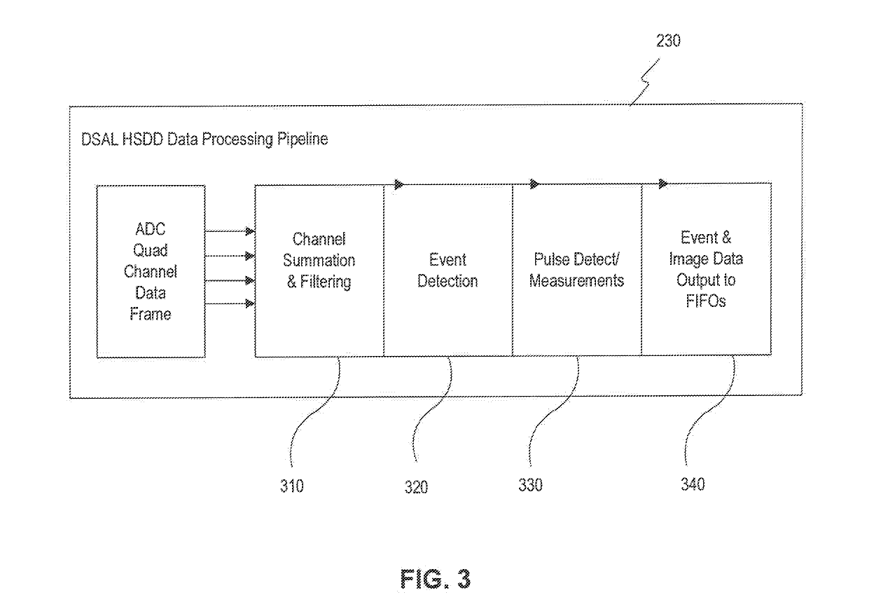

In some embodiments, data processing module 230 may perform a number of data processing operations, as shown in FIG. 3. Data processing module 230 may perform the illustrative operations in an iterative, pipelined manner for each channel. For example, data processing module 230 may include a plurality of logic components to perform channel summation and filtering processes 310, event detection operations 320, pulse detection and measurement operations 330 and output 340 the event and image data to one or more data buffers or other storage components.

The processing pipeline illustrated in FIG. 3 may implement the several pipelined processing steps to aid in the detection and tracking of an expected laser pulse or pulse chain. As part of the channel summation and filtering processes 310, data processing module 230 may generate an additional (fifth) distinct processing channel comprising a summation of the four digital data samples on channels 110a-110d. Thus, data processing module 230 may perform a number of processing operations on each of the four channels 110a-110d received from the signal detector 110 and the summed channel. Some examples of exemplary filtering operations include filtering the received pulse signals by time of arrival, width, shape, magnitude, and magnitude relative to one or more of the other digital data processing channels 110a-110d. In some embodiments, the filter parameters can be fixed or dynamically varied based on previously detected values. For example, if a pulse signal is detected with a magnitude outside of boundaries computed from previously detected pulses, either larger, smaller, or both, those pulse signals may be rejected. As another example, a filtering operation may be performed to reject one or more received pulses, if the ratio of amplitudes of the pulse signal in two or more of channels 110a-110d changes outside of some fixed or dynamically determined ratio. Numerous other filtering operations are also contemplated by the present disclosure.

As part of the event detection operation 320 of the data processing pipeline, data processing module 230 may detect a potential pulse event from the received digital data samples. Before an expected pulse signal is detected, data processing module 230 may process every digital data sample received for each of the channels, searching for potential pulse events. Data processing module 230 may be configured according to one or more parameters to detect one or more events based on the processed channels of digital data samples and the fifth summed channel.

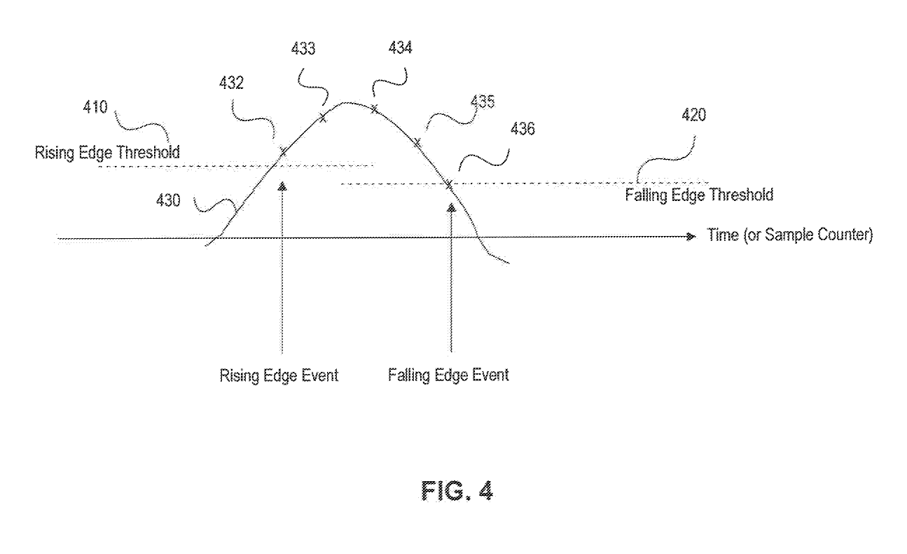

In some embodiments, as shown in FIG. 4, one or more of the parameters may establish a rising edge threshold 410 and a falling edge threshold 420 based on an expected pulse shape or other operating conditions and specifications of the laser source/emitter. The thresholds may be set to different values, as shown, to provide a dead band for hysteresis. In an exemplary embodiment, as part of event detection process 320, data processing module 230 may generate event detection data including timing information upon the detection of a threshold event. A threshold event may be determined when the digital data sample for any of the processed pipeline channels (including the summation channel) is determined to have met or exceeded the predetermined threshold. For example, as shown in FIG. 4, data processing module 230 may receive for any of the processed pipeline channels, a plurality of digital data samples, 432, 433, 434, 435, and 436 of a received laser pulse signal 430. As part of event detection operation 320, data processing module 230 may determine that a rising edge event occurred based on the value of received data sample 432 exceeding the predetermined rising edge threshold 410. Similarly, a falling edge event may be determined based on the value of received data sample 436 falling below the predetermined falling edge threshold 420. Data processing module 230 may generate event detection data based on these threshold events and store timing information corresponding to the received digital data samples 432-436 included in the detected events. In some embodiments, detection of a pulse event (additionally or alternatively) may be based on determinations regarding an amplitude, pulse width, or sequence of pulses of received pulse signals. Additionally, detection of a pulse event may also include a determination based on a sequence of prior detected pulse events using any of the above-described characteristics of received pulse signal.

The plurality of digital data samples 432-436 may be further processed by data processing module 230 to identify certain characteristics of the received laser pulse signal 430 for determining whether the received laser pulse signal 430 matches an expected pulse response. Data processing module 230 may be able to distinguish a received laser pulse signal based on the certain identified characteristics determined from the plurality of received digital data samples even under noisy conditions.

In some embodiments, event detection data may be generated for each such event detection determination and the corresponding digital data samples may be further processed in the processing pipeline according to the event detection data. Whether an event is detected based on any one channel, the digital data samples from each of the channels may be associated with the detected event for further processing. Such event detection data may be passed down the data processing pipeline to trigger further pulse detection operations or may alternatively be passed to a buffer for retrieval by digital data processor 140, for example.

As part of pulse detection and measurement operations 330, data processing module 230 may detect a pulse event based on the event detection data received from event detection processes 320 performed earlier in the pipeline. Based on the received event detection data, data processing module 230 may perform additional operations for determining whether the received digital data samples associated with the detected event correspond to a pulse signal. The pulse detection and measurement operations 330 may compare the digital samples (e.g., 432-436) associated with a detected event with an expected pulse response to determine whether the received digital data samples correspond to an expected laser pulse. For example, one or more pattern matching operations may be performed to compare the received digital samples to a pattern of the expected pulse response. Pulse detection and measurement operations 330 may also compare the timing of the detected event with other timing information of an expected pulse response to discern whether the detected event may correspond to a pulse event. Data processing module 230 may also identify various pulse characteristics such as the pulse width and time of arrival of the digital data samples corresponding to the pulse and pass such data down the pipeline for output operations 340. In some embodiments, pulse detection and measurement operations 330 may include operations based on the detected pulse events to set up one or more tracking gates and/or to adjust one or more detection and filtering parameters discussed above.

As part of output operations 340, data processing module 230 may output event detection data and pulse data received from the pipeline to one or more buffers or event storage modules, such as event storage module 260 shown in FIG. 2. Additionally, data processing module 230 may output raw image data received through the pipeline corresponding to the digital data samples output from ADC module 210 to one or more buffers or image storage modules 250. In some embodiments, output operations 340 may output event and image data to one or more buffers, such as a FIFO buffer, which may then be selectively retrieved by digital data processor 140 and/or transmitted to one or more dedicated event storage modules 260 or image storage modules 250.

As part of output operations 340, data processing module 230 may output all detected event data and raw image data to an output buffer for further processing. Alternatively, data processing module 230 may output only image data corresponding to one or more of event detection data and pulse measurement data. In this embodiment, only the raw image data corresponding to a detected event may be output for further processing by the digital data processor 140. In some embodiments, data processing module 230 may output a predetermined number of digital data samples immediately preceding or following a detected event to enable additional pre/post trigger signal data to be received for processing by the digital data processor 140. In some embodiments, the digitizer and detection module 130 may signal the digital data processor 140 when data is available in the buffers, or alternatively the digital data processor 140 may poll one or more status registers 240 of the digital detection module 200 to determine whether image or event data is available for further processing. In another embodiment, all image data may be output to one or more buffers and selectively retrieved by digital data processor 140, based on event detection data or other control and status information, as desired.

Digital data processor 140 may apply advanced signal processing to the raw image data retrieved from data processing module 230. In some embodiments, digital data processor 140 may perform the advanced signal processing only on the raw image data corresponding to a detected event thus reducing the amount of data for processing. An example of the signal processing functionality of digital data processor 140 may include curve fitting operations to determine a shape of the received signal corresponding to the digital data samples of the detected events. Advanced curve fitting operations on the plurality of samples may enable system 100 to precisely determine whether the detected shape of the received signal corresponds to an expected pulse response of the intended laser signal. Digital data processor 140 may perform a number of curve fit operations to determine which, if any, of the detected events correspond to the expected pulse response. Additionally, a precise curve fit may enable the system 100 to determine the peak time of arrival of the expected pulse response, which may enable system 100 to distinguish the expected pulse from closely spaced signals corresponding to other background reflections. As such, digital data processor 140 may be able to reject undesired noise such as multi-path and other laser energy reflections received by signal detector 110, based on the precise pulse shape characteristics and timing information. Under certain operating conditions, an expected pulse response may be detected in the digital data samples of a single pulse interval. Under low signal-to-noise conditions, however, system 100 may compare a plurality of curve fit determinations and perform other processes over a plurality of pulse intervals to identify the expected pulse response.

Additionally, digital data processor 140 may provide additional functionality based on the detected expected pulse response. For example, digital data processor 140 may perform software controlled functionality to output a guidance command or determine a precise range of the signal detector from a target reflecting a signal from a source based on the digital signal data corresponding to the expected pulse. Such functionality may be performed on the raw digital data samples corresponding to the detected expected pulse response output from data processing module 230.

Once an expected pulse response is detected, whether from a single pulse interval or over a plurality of pulse intervals, the pipelined operations of data processing module 230 may, according to one or more of the control or status registers 240, limit certain data processing to a period of time within the pulse interval corresponding to an anticipated arrival of the expected pulse response. In some embodiments, the signal source, such as a laser source/emitter may output a laser pulse chain with a pulse interval of a predetermined periodic frequency, thus enabling detection system 100 to limit processing operations for those time periods within the pulse interval when it expects to receive the desired laser pulse response. In other embodiments, a laser source/emitter may output a signal with a random or pseudorandom pulse interval known by detection system 100, and system 100 may dynamically configure one or more of the control or status registers 240 to limit data processing according to the known pulse interval.

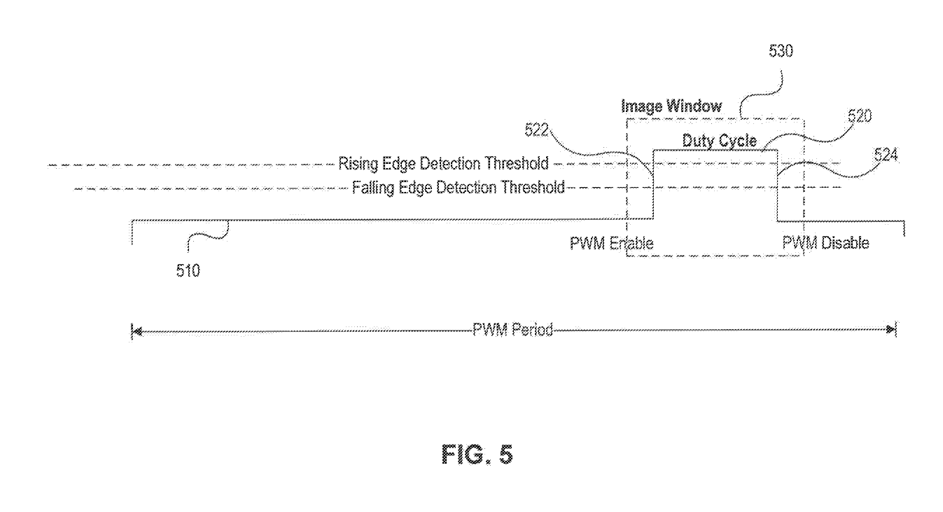

In some embodiments, one or more of the control and status registers 240 may be configured by digital data processor 140 or other processing modules, such as event manager 280 and image manager 270 to control the operations of data processing module 230. One or more control and status registers 240 may control one or more of the logic components in data processing module 230 according to a control signal. In some embodiments, the control signal may be a Pulse Width Modulation (PWM) signal 510, as shown in FIG. 5. The PWM signal 510 may be configured by a PWM Enable 522 and PWM Disable 524 marker to establish a PWM duty cycle 520 as shown, which may comprise a programmable tracking gate for detecting an expected pulse response. In some embodiments, the width of the duty cycle 520 and placement within the PWM period closely approximates the width of the expected laser pulse signal and its position within a pulse interval. In some embodiments, data processing module 230 may reject digital data samples received outside the duty cycle window 520 and process only those digital data samples corresponding to events detected within the duty cycle window 520. In other embodiments, the PWM period may include multiple high/low regions (in a periodic or arbitrary manner) establishing multiple duty cycle regions (not shown) within the PWM period. As such, data processing module 230 may implement multiple tracking windows for tracking a plurality of expected pulse response signals from one or more pulse chains, such as for example, where more than one source signal may be implemented.

In another embodiment, data processing module 230 may be configured according to one or more control signals to track and process digital data samples received in an image window 530, over a duration greater than the duty cycle, as shown in FIG. 5. In such an embodiment, processing of data received within the image window 530 may enable tracking of an expected pulse signal that may shift its relative position within a PWM period due to changes in relative distance between the signal detector and a target, or to ensure detection of the expected pulse response under noisy conditions or other background reflections close to the target. Thus, data processing module 230 may process additional digital data samples received outside the duty cycle 520 of a PWM period.

In some embodiments, an image window 530 may be established that does not overlap with the duty cycle 520 of the PWM period. For example, data processing module 230 may output digital data samples of each of the channels and the summed channel for any suitable temporal region for further processing by digital data processor 140, while tracking the expected pulse response during the PWM period. Such functionality may be implemented via a control signal from one or more control and status registers 240 to process the image data samples received during the image window period. Additionally, data processing module 230 may selectively output raw image data corresponding to the image window period (and any other detected events) to one or more output buffers for retrieval by digital signal processor 140.

The exemplary configuration of the digitizer and detection module 130 may enable many programmable variations of the above embodiments to selectively process and output received digital data samples according to a desired operation. While data processing module 230 may detect and process each pulse event based on the threshold edge detection processes detailed above, data processing module 230 may also process additional triggered events under the direction of one or more control and status registers 240. For example, one or more control or status registers may be programmed or directed by one or more processing modules, such as digital data processor 140, image manager 270, or event manager 280 to trigger an event in the data processing module 230. As such, data processing module 230 may process additional events instructed from outside the pipeline process. The triggered events may include an “on-demand” event request or may be some other programmable timer-based event.

Data processing module 230 may generate event detection data upon receipt of one or more event trigger signals received from one or more of control and status registers 240 as part of event detection processes 320. The event detection data may include time of arrival data corresponding to the received digital data samples. As the triggered event digital data samples are processed further in the processing pipeline, data processing module 230, as part of pulse detection and measurement operations 330, may determine whether the triggered event occurred inside or outside of the duty cycle 520 of the PWM period, thus discriminating the digital data samples from expected pulse samples. As part of output operations 340, data processing module 230 may output the triggered event detection data along with the raw image data corresponding to the triggered event to one or more output buffers for retrieval by the digital data processor 140 for follow-on signal processing. Digital data processor 140 may selectively retrieve event and image data from the one or more output buffers, as desired based on the event detection data, for example.

Thus, in some embodiments, system 100 may simultaneously focus on an expected pulse response chain while also processing other triggered events (either controlled by the system 100 or detected in the pipeline from the received signal). The data throughput speed of pipelined data processing module 230 may enable the system to perform processing operations on all received digital data samples or only those samples of a particular interest at substantially the rate of a system clock signal operating at a frequency up to 125 Mhz and above. At such data processing speeds, system 100 may precisely determine, based on a plurality of digital data samples, pulse shape characteristics of an expected pulse response and distinguish the expected pulse response from other received signals, even in low signal-to-noise conditions, and perform many other advanced signal processing operations as desired for particular functionality.

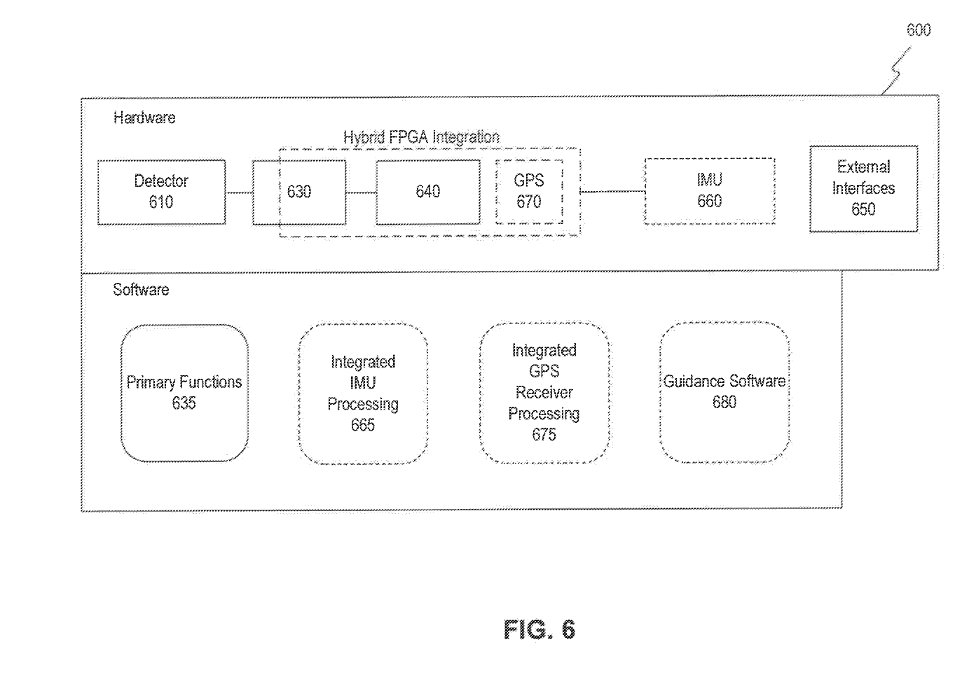

Detection and processing system 100 may be implemented in a variety of configurations as desired for a particular application. In some embodiments, system 100 may be included as part of a laser alignment system for aligning a moving object hosting the signal detector 110 with a target reflecting a laser source signal. FIG. 6 illustrates an exemplary configuration of a laser alignment system 600 in some embodiments.

As shown in FIG. 6, an exemplary laser alignment system 600 may include a plurality of hardware components and software components. In some embodiments, laser alignment system 600 may include an analog signal detector 610, digitizer and detector module 630, and digital data processing module 640, similar to signal detector 110, digitizer and detector circuitry and digital data processor 140, detailed above. As shown, certain components and functionality of the digitizer and detector module 630 and data processing module 640 may be closely interconnected or integrated onto an FPGA fabric. Laser alignment system 600 may also include an external interface 650 for communicating with other external system components, such as a guidance system. External interface 650 may include a known UART serial interface and/or other SPI interface as known in the art.

In some embodiments, laser alignment system 600 may include an optional inertial measurement unit (IMU) 660 comprising one or more accelerometers for determining an angular rate and linear acceleration of the moving object, for example. Such IMU 660 may provide data used to estimate the motion of the moving object and to stabilize its movement where an inertially stabilized system may not be possible or practical. Additionally IMU 660 may provide data enabling laser alignment 660 to correct or compensate for detected object movement such that motion of the detector system may be discerned from motion of a tracked laser object.

In some embodiments, a GPS receiver module 670 may also be configured as a separate component or integrated within the integration of digitizer and detector module 630, and digital data processing module 640 on the FPGA, for example. GPS receiver module 670 may enable course acquisition functionality to augment the system's 600 guidance capability by assisting in guidance prior to laser detection and tracking. For example, before laser alignment system is able to detect or track a reflected signal received from a target, the GPS receiver module 670 may provide data to enable digital data processing module 640, for example, to generate guidance commands. GPS module 670 may also augment the IMU 660 by providing inertial position and attitude information that can be used to determine an inertial roll position of a moving object hosting the laser alignment system 600.

In the embodiment shown in FIG. 6, laser alignment system 600 may include a plurality of software modules storing one or more sets of instructions executable by one or more processing components of the laser alignment system 600 for performing desired functionality. The one or more software modules may be included in a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, nonvolatile memory, and any other known physical storage medium.

In some embodiments, laser alignment system 600 may include a primary function software module 635 that stores one ore more software instructions for controlling the functionality of the digitizer and detector module 630, and digital data processing module 640. In some embodiments, primary function module 635 includes a plurality of instructions for configuring the integrated FPGA of digitizer and detector module 630, and digital data processing module 640 and controlling the other signal search, event generation, event detection, tracking, advanced signal processing and other functions detailed above. Primary function module 635 may also include instructions for controlling the one or more control and status registers 240 (FIG. 2) to control operation of digital detection module 200 detailed above.

Laser alignment system 600 may also include an IMU processing module 665 and a GPS processing module 675 storing one or more sets of instructions executable by the IMU 660 and GPS receiver module 670 to perform the desired functionality. Laser alignment system 600 may also include guidance software module 680 providing one or more instructions executable by digital data processing module 640, for example, to generate line of sight (LOS) guidance commands to direct a moving object to the target based on received image data from digitizer and detector module 630 or GPS data that may be provided before digitizer and detector module 630 is capable of detecting and tracking an expected laser reflection from the target. In some embodiments, guidance software module 680 may provide other executable instructions directing digital data processing module 640 to perform processes to control the system hardware to capture and determine two dimensional LOS angles or error terms that provide a measure of the angular offset of the received laser energy from the center of the detector 110, as is known in the art. These signals can then be used by a motion control system (not shown) for precision alignment with respect to a laser designated target, for example.

It will be apparent to those skilled in the art that various modifications and variations can be made to the system of the present disclosure. Other embodiments of the system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A laser alignment system comprising:
a multi-channel optical detector including a plurality of light sensitive regions, each light sensitive region being associated with a respective one of a plurality of channels of the multi-channel optical detector and being configured to detect energy of an incident laser pulse; and
a signal processing unit configured to:
determine a plurality of data samples associated with a detected laser pulse;
determine whether the plurality of data samples correspond to an expected laser pulse response; and
output an alignment command based at least in part on the plurality of data samples associated with the detected laser pulse when the detected laser pulse corresponds to the expected laser pulse response.

2. The laser alignment system of claim 1, wherein the signal processing unit includes one or more analog-to-digital converter components configured to convert an analog signal on each of the plurality of channels associated with the detected energy of an incident laser pulse to the plurality of digital data samples for each of the plurality of channels.

3. The laser alignment system of claim 2, wherein the one or more analog-to-digital converter components is configured to sample the analog signal on each of the plurality of channels according to a clock signal with a frequency at or above 125 Mhz.

4. The laser alignment system of claim 2, further comprising a first analog-to-digital converter component configured to sample the analog signal on each of the plurality of channels according to a rising edge of a clock signal, and a second analog-to-digital converter component configured to sample the analog signal on each of the plurality of channels according to a falling edge of a clock signal.

5. The laser alignment system of claim 2, further comprising a data detection module configured to receive the plurality of digital data samples for each of the plurality of channels, determine a sum of the digital data samples, and generate a summed channel associated with the sum of the digital data samples.

6. The laser alignment system of claim 5, wherein the data detection module comprises an FPGA configured to process the digital data samples for each of the plurality of channels and the summed channel, the FPGA configured to perform one or more operations on each digital data sample in a pipeline fashion.

7. The laser alignment system of claim 6, wherein the FPGA is configured to perform an operation on each digital data sample for the plurality of channels and the summed channel substantially simultaneously according to the clock signal.

8. The laser alignment system of claim 5, wherein the data detection module is further configured to determine whether a digital data sample on any of the plurality of channels or the summed channel meets or exceeds a predetermined threshold.

9. The laser alignment system of claim 8, wherein the data detection module is further configured to generate event detection data when a digital data sample meets or exceeds the predetermined threshold, the event detection data including timing information corresponding to the digital data sample.

10. The laser alignment system of claim 9, wherein the data detection module is configured to determine whether the timing information of the event detection data indicates the digital data sample was received within an anticipated time interval for receiving an expected laser pulse response.

11. The laser alignment system of claim 9, wherein the data detection module is further configured to determine a plurality of digital data samples corresponding to a pulse event based in part on the event detection data.

12. The laser alignment system of claim 1, wherein the data detection module is configured to output the plurality of digital data samples corresponding to the pulse event, the plurality of digital data samples include digital data for each of the plurality of channels and the summed channel associated with the pulse event.

13. The laser alignment system of claim 12, wherein the signal processing unit comprises a digital data processor configured to determine a curve for the plurality of digital data samples corresponding to the pulse event, the curve indicating a pulse shape of the plurality of digital data samples.

14. The laser alignment system of claim 13, wherein the digital data processor is configured to determine whether the plurality of digital data samples corresponds to the expected laser pulse response based in part on a comparison of the pulse shape with an expected pulse shape response.

15. A computer readable medium that comprises a set of instructions executable by at least one processor to cause the at least one processor to perform a method for aligning a movable object with a target reflecting a detected laser pulse signal, the method comprising the following operations:
determining a plurality of data samples associated the detected laser pulse;
determining whether the plurality of data samples correspond to an expected laser pulse response; and
outputting an alignment command based at least in part on the plurality of data samples associated with the detected laser pulse when the detected laser pulse response corresponds to the expected laser pulse response.

16. The computer readable medium of claim 15, wherein the set of instructions include instructions for configuring an FPGA to process the plurality of data samples in a pipeline fashion for determining whether the plurality of data samples correspond to an expected laser pulse response.

17. The computer readable medium of claim 16, wherein the set of instructions include instructions for configuring the FPGA to receive a plurality of digital data samples associated with a plurality of channels of a multi-channel optical detector, and determine whether a digital data sample on any of the plurality of channels meets or exceeds a predetermined threshold.

18. The computer readable medium of claim 17, wherein the set of instructions include instructions for configuring the FPGA to generate event detection data when a digital sample meets or exceeds the predetermined threshold, the event detection data including timing information correspond to the digital data sample.

19. The computer readable medium of claim 18, wherein the set of instructions include instructions for configuring the FPGA to determine whether the timing information of the event detection data indicates the digital data sample was received within an anticipated time interval for receiving the expected laser pulse response; and determine a plurality of digital data samples corresponding to a pulse event based in part on the event detection data.

20. The computer readable medium of claim 19, wherein the method further includes:
determining a curve for the plurality of digital data samples corresponding to the pulse event, the curve indicating a pulse shape of the plurality of digital data samples; and
determining whether the plurality of digital data samples corresponds to the expected laser pulse response based in part of a comparison of the pulse shape with an expected pulse shape response.
